(19) United States
(12) Patent Application Publication
(10) Pub. No.: US 2026/0178111 A1
(43) Pub. Date: Jun. 25, 2026

(54) Method for Improving Efficiency of Multi-Core Processor Systems

(71) Applicant: Reed Semiconductor Corporation, Warwick, RI (US)

(72) Inventors: Wenkai Wu, East Greenwich, RI (US); Weidong Zhu, East Lyme, CT (US)

(21) Appl. No.: 19/428,219

(22) Filed: Dec. 21, 2025

Related U.S. Application Data
(60) Provisional application No. 63/737,773, filed on Dec. 22, 2024.

(51) Int. Cl. G06F 1/3296; G06F 1/3287

(52) U.S. Cl. CPC G06F 1/3296; G06F 1/3287

(57) ABSTRACT

A method includes configuring a plurality of power converters to provide power to a plurality of processor cores, wherein each power converter of the plurality of power converters is connected to a corresponding processor core, and in response to a system command, configuring at least one of the plurality of power converters to leave a first operating mode and enter a second operating mode to reduce a leakage current flowing through a processor core connected to the at least one of the plurality of power converters.

### PRIORITY

This application claims the benefit of U.S. Provisional Application No. 63/737,773, filed on Dec. 22, 2024, entitled “Method for Improving Efficiency of Multi-Core Processor Systems,” which application is hereby incorporated herein by reference.

### TECHNICAL FIELD

The present disclosure relates generally to the field of integrated circuits, and in particular embodiments, to techniques and mechanisms for improving efficiency of multi-core processor systems.

### BACKGROUND

As technologies further advance, a variety of processors such as Digital Signal Processors (DSPs), Field Programmable Gate Arrays (FPGAs), Central Processing Units (CPUs) and/or the like, have become popular. Each processor operates with a low supply voltage (e.g., sub-1V) and consumes a large amount of current. In modern processors, computational efficiency and power management are critical considerations. Many processors incorporate multiple cores to enhance processing performance and support parallel computing tasks. These cores are typically arranged in a grid-like configuration comprising a plurality of rows and columns. This spatial arrangement enables streamlined inter-core communication and resource allocation.

To ensure consistent and efficient power delivery to the processor cores, vertical power delivery networks are employed. These networks include a plurality of power stages strategically arranged in rows and columns to align with the processor cores. The power stages are typically mounted on a side of a multilayer substrate opposite to the processor cores, and power is delivered through vertical conductive paths, such as vias, interconnects or the like, formed within the multilayer substrate. By delivering power vertically from the power stages to the processor cores, resistive losses and parasitic effects associated with long horizontal routing paths are reduced, thereby improving power efficiency and voltage regulation accuracy of the power conversion system.

The power conversion system comprises a Pulse Width Modulation (PWM) controller and a plurality of power stages. The PWM controller is an integrated circuit designed to manage and regulate power delivery in systems requiring high efficiency and stability. This type of controller is commonly used in power supplies for processors consuming a large amount of current. The PWM controller is configured to control the plurality of power stages by generating multiple PWM signals. The primary objective is to enhance power efficiency and improve overall performance. In operation, the PWM controller generates precise PWM signals for the plurality of power stages. These signals are used to control the switching of power switches in each power stage, regulating the voltage and current supplied to the load.

In operation, some processor cores may be subjected to heavy computational loads, while others remain idle. The voltage applied to non-working processor cores can cause leakage currents, resulting in unnecessary power losses. This is a significant issue in existing systems, as it impacts overall power efficiency and thermal performance.

The arrangement of power stages and their alignment with processor cores is an essential aspect of maintaining optimal performance and thermal management in multi-core processors. As processors continue to evolve with higher core counts and greater power demands, innovations in vertical power delivery systems remain critical for meeting these challenges. It would be desirable to address the issue of power losses due to leakage currents in non-working cores. The present disclosure addresses this need.

### SUMMARY

Technical advantages are generally achieved, by embodiments of this disclosure which describe methods for improving efficiency of multi-core processor systems.

In accordance with an embodiment, a method comprises configuring a plurality of power converters to provide power to a plurality of processor cores, wherein each power converter of the plurality of power converters is connected to a corresponding processor core, and in response to a system command, configuring at least one of the plurality of power converters to leave a first operating mode and enter a second operating mode to reduce a leakage current flowing through a processor core connected to the at least one of the plurality of power converters.

In accordance with another embodiment, a method comprises mounting a plurality of processor cores on a first side of a multilayer substrate and a plurality of power converters on a second side of the multilayer substrate, wherein each power converter of the plurality of power converters is electrically connected to a corresponding processor core, configuring the plurality of power converters to provide power to the plurality of processor cores, configuring at least one of the plurality of power converters to regulate a voltage applied to a processor core electrically coupled to the at least one of the plurality of power converters when the processor core is in an active operating mode, and configuring the at least one of the plurality of power converters to reduce the voltage applied to the processor core, thereby reducing a leakage current flowing through the processor core when the processor core is in an idle operating mode.

In accordance with yet another embodiment, a system comprises a plurality of processor cores disposed on a first side of a multilayer substrate, a plurality of power converters disposed on a second side of the multilayer substrate, wherein each of plurality of power converters comprises a smart power stage, an inductor and an output capacitor, and wherein the smart power stage comprises a driver, a high side switch and a low side switch, a plurality of conductive paths in the multilayer substrate and coupled between the plurality of power converters and the plurality of processor cores, wherein through the plurality of conductive paths, each power converter of the plurality of power converters is electrically connected to a corresponding processor core, and a controller configured to control at least one of the plurality of power converters to leave a first operating mode and enter a second operating mode, thereby reducing a leakage current flowing through a processor core connected to the at least one of the plurality of power converters.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a power conversion system configured to provide power to a multi-core processor system in accordance with various embodiments of the present disclosure;

FIG. 2 illustrates a system configuration of the power conversion system and the multi-core processor system in accordance with various embodiments of the present disclosure;

FIG. 3 illustrates a schematic diagram of the smart power stage shown in FIG. 1 in accordance with various embodiments of the present disclosure;

FIG. 4 illustrates a flow chart of a method for controlling the power conversion system shown in FIG. 1 in accordance with various embodiments of the present disclosure; and

FIG. 5 illustrates a flow chart of another method for controlling the power conversion system shown in FIG. 1 in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to embodiments in a specific context, namely methods for improving efficiency of multi-core processor systems. The disclosure may also be applied, however, to a variety of processor systems. Hereinafter, various embodiments will be explained in detail with reference to the accompanying drawings.

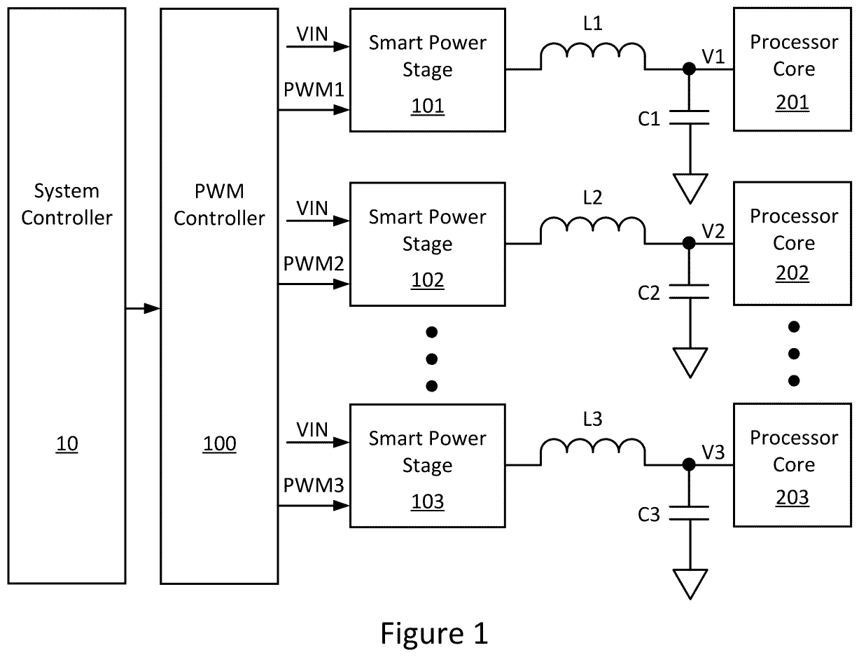

FIG. 1 illustrates a block diagram of a power conversion system configured to provide power to a multi-core processor system in accordance with various embodiments of the present disclosure. The power conversion system comprises a system controller 10, a PWM controller 100, a plurality of smart power stages 101, 102, and 103, a plurality of inductors L1, L2 and L3, and a plurality of output capacitors C1, C2 and C3. As shown in FIG. 1, the PWM controller 100 is connected between the system controller 10 and the plurality of smart power stages 101, 102 and 103.

As shown in FIG. 1, the first smart power stage 101 and the inductor L1 are connected in series to form a first power conversion stage. In some embodiments, the first power conversion stage is a first step-down power conversion stage. As shown in FIG. 1, the first step-down power conversion stage is connected between an input voltage bus VIN and a first output voltage bus V1. The first output capacitor C1 is connected between the first output voltage bus V1 and ground. The first power conversion stage and the first output capacitor C1 form a first power converter. The first output voltage bus V1 is connected to the first processor core 201.

The second smart power stage 102 and the inductor L2 are connected in series to form a second power conversion stage. In some embodiments, the second power conversion stage is a second step-down power conversion stage. As shown in FIG. 1, the second step-down power conversion stage is connected between the input voltage bus VIN and a second output voltage bus V2. The second output capacitor C2 is connected between the second output voltage bus V2 and ground. The second power conversion stage and the second output capacitor C2 form a second power converter. The second output voltage bus V2 is connected to the second processor core 202.

The third smart power stage 103 and the inductor L3 are connected in series to form a third power conversion stage. In some embodiments, the third power conversion stage is a third step-down power conversion stage. As shown in FIG. 1, the third step-down power conversion stage is connected between the input voltage bus VIN and a third output voltage bus V3. The third output capacitor C3 is connected between the third output voltage bus V3 and ground. The third power conversion stage and the third output capacitor C3 form a third power converter. The third output voltage bus V3 is connected to the third processor core 203.

It should be noted that FIG. 1 illustrates only three smart power stages of a power conversion system that may include hundreds of such smart power stages. The number of smart power stages illustrated herein is limited solely for the purpose of clearly illustrating the inventive aspects of the various embodiments. The present disclosure is not limited to any specific number of smart power stages.

The PWM controller 100 is configured to receive various system commands from the system controller 10. Based on a variety of operating parameters and the system commands, the PWM controller 100 is configured to generate a plurality of PWM signals for controlling the plurality of smart power stages 101, 102 and 103. More particularly, the PWM controller 100 feeds a first PWM signal PWM1 to the first smart power stage 101. The PWM controller 100 feeds a second PWM signal PWM2 to the second smart power stage 102. The PWM controller 100 feeds a third PWM signal PWM3 to the third smart power stage 103.

As shown in FIG. 1, the multi-core processor system comprises a plurality of processor cores including a first processor core 201, a second processor core 202 and a third processor core 203. It should be noted that FIG. 1 illustrates only three processor cores of a multi-core processor system that may include hundreds of such processor cores. The number of processor cores illustrated herein is limited solely for the purpose of clearly illustrating the inventive aspects of the various embodiments. The present disclosure is not limited to any specific number of processor cores.

As shown in FIG. 1, the output of the first power conversion stage is connected to the first processor core 201. The first power conversion stage is configured to provide power for the first processor core 201. The output of the second power conversion stage is connected to the second processor core 202. The second power conversion stage is configured to provide power for the second processor core 202. The output of the third power conversion stage is connected to the third processor core 203. The third power conversion stage is configured to provide power for the third processor core 203.

In operation, as shown in FIG. 1, the system controller 10 is configured to issue system commands to the PWM controller 100 to manage operating states of the plurality of power converters formed by the smart power stages 101-103, inductors L1-L3, and output capacitors C1-C3. Each power converter is coupled to a corresponding processor core 201-203 and is configured to provide a regulated supply voltage thereto.

In operation, the system controller 10 is configured to monitor operating states of the plurality of processor cores. After determining that one or more processor cores are in an idle operating state, the system controller 10 sends a system command to the PWM controller 100. In response to the system command, the PWM controller 100 configures at least one of the plurality of power converters to leave a first operating mode and enter a second operating mode to reduce a leakage current flowing through the corresponding processor core. Depending on different applications and design needs, the first operating mode and the second operating mode may employ different control schemes, which are described in further detail below.

In some embodiments, in the first operating mode, the PWM controller 100 configures the at least one power converter to regulate an output voltage to a voltage level specified by the corresponding processor core. In the second operating mode, the PWM controller 100 disables the at least one power converter, thereby substantially eliminating an output voltage supplied to the processor core and reducing leakage current when the processor core is inactive. As used herein, disabling the power converter comprises configuring the PWM controller 100 such that both a high side switch and a low side switch of the power converter are prevented from switching.

In some embodiments, in the first operating mode, the PWM controller 100 configures the at least one power converter to regulate an output voltage to a voltage level specified by the corresponding processor core. In the second operating mode, the PWM controller 100 configures the at least one power converter to regulate its output voltage to substantially zero volts. By driving the output voltage to zero, leakage current through the processor core coupled to the power converter is reduced while maintaining a controlled transition between the first and second operating modes.

In some embodiments, in the first operating mode, the PWM controller 100 configures the at least one power converter to regulate an output voltage to a voltage level specified by the corresponding processor core. In the second operating mode, the PWM controller 100 configures the at least one power converter to operate with a minimum duty cycle. Operating the power converter at the minimum duty cycle reduces the output voltage and output energy delivered to the processor core, thereby reducing leakage current while allowing rapid reactivation when exiting the second operating mode and entering into the first operating mode. In some embodiments, the minimum on-time associated with the minimum duty cycle is in a range from about 20 nanoseconds to about 50 nanoseconds.

In some embodiments, in the first operating mode, the PWM controller 100 configures the at least one power converter to regulate an output voltage to a voltage level specified by the corresponding processor core. In the second operating mode, the PWM controller 100 configures the at least one power converter to regulate its output voltage to a level slightly below a leakage current threshold voltage of the corresponding processor core. Maintaining the output voltage below the leakage threshold reduces static leakage current while preserving a pre-biased voltage state for faster wake-up. In some embodiments, the leakage current threshold voltage of the corresponding processor core is in a range from about 0.2 V to about 0.4 V. In some embodiments, the at least one power converter regulates its output voltage in a range from about 0.12 V to about 0.18 V.

In some embodiments, in the first operating mode, the PWM controller 100 configures the at least one power converter to regulate an output voltage to a voltage level specified by the corresponding processor core. In the second operating mode, the PWM controller 100 configures the at least one power converter to regulate its output voltage to substantially zero volts and to operate with a variable switching frequency lower than the switching frequency of the power conversion system. In some embodiments, the switching frequency of the power conversion system is in a range from 500 kHz to 1.5 MHz. The variable switching frequency reduces power consumption of the power converter while the processor core is inactive.

In some embodiments, in the first operating mode, the PWM controller 100 configures the at least one power converter to regulate an output voltage to a voltage level specified by the corresponding processor core. In the second operating mode, the PWM controller 100 configures the at least one power converter to operate with a minimum duty cycle and a variable switching frequency lower than the switching frequency of the power conversion system in the first operating mode. This operating combination reduces both switching losses and control overhead, thereby minimizing power consumption during idle periods of the processor core.

In some embodiments, in the first operating mode, the PWM controller 100 configures the at least one power converter to regulate an output voltage to a voltage level specified by the corresponding processor core. In the second operating mode, the PWM controller 100 configures the at least one power converter to operate with a minimum duty cycle and a fixed switching frequency. In some embodiments, the fixed switching frequency in the second operating mode is lower than the switching frequency of the power conversion system in the first operating mode. Maintaining a fixed switching frequency allows the power converter to achieve a faster transient response when transitioning back to the first operating mode.

In some embodiments, in the first operating mode, the PWM controller 100 configures the at least one power converter to regulate an output voltage to a voltage level specified by the corresponding processor core. In the second operating mode, the PWM controller 100 configures the at least one power converter to regulate its output voltage to a level slightly below the leakage current threshold voltage of the processor core and to operate with a variable switching frequency lower than the switching frequency of the power conversion system in the first operating mode. This configuration reduces leakage current while further reducing overall power consumption of the power conversion system.

In some embodiments, in the first operating mode, the PWM controller 100 configures the at least one power converter to regulate an output voltage to a voltage level specified by the corresponding processor core. In the second operating mode, the PWM controller 100 configures the at least one power converter to regulate its output voltage to a level slightly below the leakage current threshold voltage of the processor core and to operate with a fixed switching frequency. In some embodiments, the fixed switching frequency in the second operating mode is lower than the switching frequency of the power conversion system in the first operating mode. Operating with a fixed switching frequency enables a faster transient response when the processor core is reactivated.

In some embodiments, when the system command indicates a short sleep time for the at least one power converter, the PWM controller 100 configures the at least one power converter to operate with a minimum duty cycle and a fixed switching frequency lower than a switching frequency used in the first operating mode. This configuration balances reduced leakage current with a fast recovery time for resuming active operation of the processor core.

In some embodiments, when the system command indicates a short sleep time for the at least one power converter, the PWM controller 100 configures the at least one power converter to regulate its output voltage to a level slightly below the leakage current threshold voltage of the processor core and to operate with a fixed switching frequency lower than a switching frequency used in the first operating mode, thereby reducing leakage current while enabling rapid wake-up.

In some embodiments, when a processor core enters an idle operating mode, the PWM controller 100 is configured to control the corresponding power converter to enter the second operating mode through reducing the voltage applied to the processor core in a gradual and staged manner. For example, the PWM controller 100 may first control the corresponding power converter to reduce the output voltage to a level slightly below a leakage current threshold voltage of the processor core. The PWM controller 100 may then further reduce the output voltage to a voltage corresponding to a minimum duty cycle of the power converter. Thereafter, the output voltage may be further reduced to substantially zero. After the output voltage reaches substantially zero, the PWM controller 100 may disable the power converter by stopping switching activity of the power converter, thereby minimizing leakage current and power consumption.

An advantage of reducing the voltage in the gradual and staged manner described above is that the power converter can maintain a state that enables a fast transient response when the processor core transitions between idle and active operating modes. In practical operation, a processor core may rapidly and repeatedly switch between active and idle states. By first reducing the voltage to a level slightly below the leakage current threshold, and then to a voltage corresponding to a minimum duty cycle before reaching zero voltage and stopping switching activity, the power converter avoids an abrupt shutdown. As a result, when the processor core returns to the active operating mode, the power converter can more quickly resume operation and provide the regulated voltage specified by the processor core, thereby improving response time and overall system performance.

In some advanced embodiments, the gradual reduction of the voltage applied to the processor core is further coordinated with control of the switching frequency of the power converter. For example, when a processor core transitions toward an idle operating mode, the PWM controller 100 may first regulate the output voltage to a level slightly below a leakage current threshold voltage of the processor core while operating the power converter with a fixed switching frequency. The PWM controller 100 may then continue to regulate the output voltage at the level slightly below the leakage current threshold voltage while operating the power converter with a variable switching frequency (e.g., a power saving mode) to further reduce power consumption. The PWM controller 100 may thereafter reduce the output voltage to a voltage corresponding to a minimum duty cycle while operating with a fixed switching frequency, followed by operating with a variable switching frequency (e.g., a power saving mode) at the minimum duty cycle. The output voltage may then be further reduced to substantially zero while operating with a fixed switching frequency, followed by operating with a variable switching frequency at substantially zero voltage. After these stages, the PWM controller 100 may disable the power converter by stopping switching activity. Such coordinated control of voltage level and switching frequency enables power reduction while preserving fast recovery capability when the processor core returns to an active operating mode.

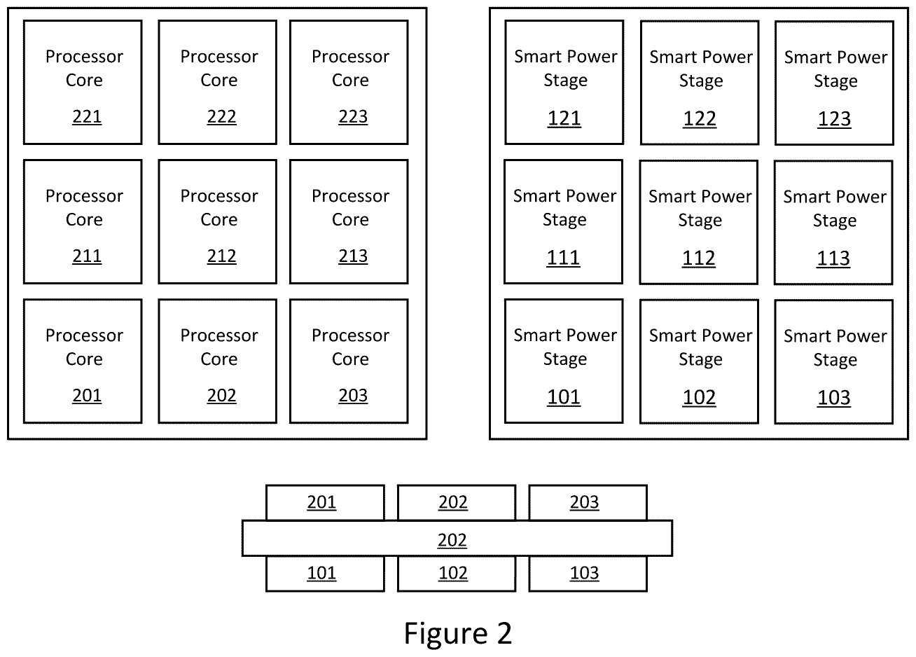

FIG. 2 illustrates a system configuration of the power conversion system and the multi-core processor system in accordance with various embodiments of the present disclosure. In some embodiments, the multi-core processor system comprises nine processor cores 201, 202, 203, 211, 212, 213, 221, 222 and 223 mounted on a first side of a multilayer substrate 200. As shown in FIG. 2, a top view of the first side of the multilayer substrate 200 shows that the processor cores 201-203, 211-213 and 221-223 are arranged in a grid-like configuration comprising three rows and three columns. In some embodiments, the power conversion system comprises nine smart power stages 101, 102, 103, 111, 112, 113, 121, 122 and 123 mounted on a second side of a multilayer substrate 200. As shown in FIG. 2, a top view of the first side of the multilayer substrate 200 shows that the smart power stages 101-103, 111-113 and 121-123 are arranged in a grid-like configuration comprising three rows and three columns.

It should be noted that the number of smart power stages and the number of processor cores illustrated herein are limited solely for the purpose of clearly illustrating the inventive aspects of the various embodiments. The present disclosure is not limited to any specific number of smart power stages and/or any specific number of processor cores.

As shown in FIG. 2, a cross-section view shows that the processor cores are mounted on the first side of the multilayer substrate 200, and the smart power stages are mounted on the second side of the multilayer substrate 200. In some embodiments, the nine smart power stages are arranged in rows and columns to align with the corresponding processor cores. Each smart power stage (e.g., smart power stage 101) is designed to deliver power directly to a corresponding processor core (e.g., processor core 201) through vertical pathways (e.g., vias, interconnects and the like) in the multilayer substrate 200. This configuration minimizes power loss and ensures reliable power distribution.

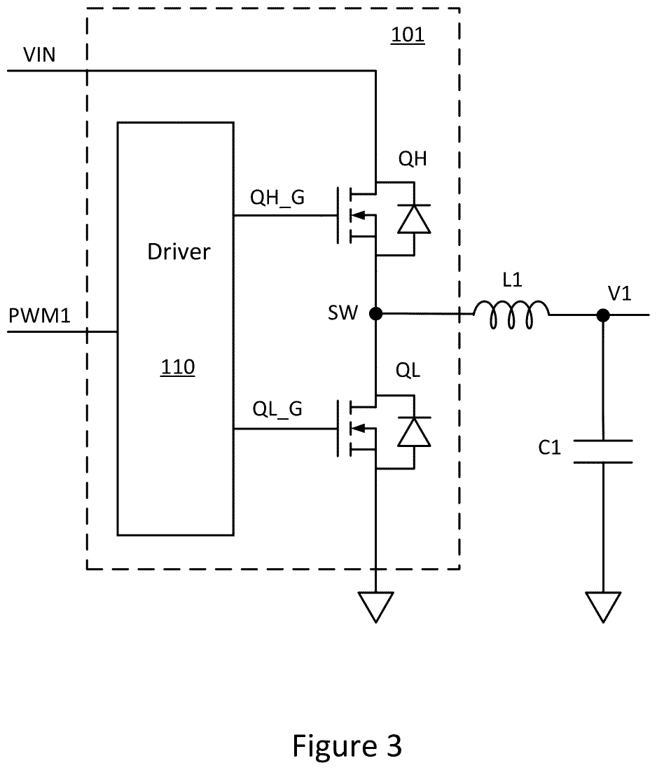

FIG. 3 illustrates a schematic diagram of the smart power stage shown in FIG. 1 in accordance with various embodiments of the present disclosure. In some embodiments, the smart power stages shown in FIG. 2 share the same power topology, and the smart power stage 101 is used to illustrate this power topology. It should be noted that the power topology shown in FIG. 3 is merely an example and should not be construed as limiting the scope of the present disclosure.

The smart power stage 101 comprises a high side switch QH, a low side switch QL and a driver 110. As shown in FIG. 3, the high side switch QH and the low side switch QL are connected in series between the input voltage bus VIN and ground. An output inductor L1 is connected between a common node (SW) of the high side switch QH and the low side switch QL, and the output voltage bus V1. The output capacitor C1 is connected between the output voltage bus V1 and ground. The driver 110 is configured to receive a PWM signal (PWM1) from the PWM controller 100. Based on the received PWM signal, the driver 110 generates gate drive signals QH_G and QL_G for the high side switch QH and the low side switch QL, respectively. In some embodiments, the high side switch QH, the low side switch QL and the driver 110 are in a smart power stage semiconductor package.

In operation, when the high side switch QH is turned on, and the low side switch QL is turned off, a current flows from the input voltage VIN to the load through the output inductor L1. The output inductor L1 opposes sudden changes in current by storing energy in its magnetic field. The output capacitor C1 supplies the load with current, smoothing out the output voltage V1. When the high side switch QH is turned off, and the low side switch QL is turned on, the output inductor L1 releases its stored energy to maintain the current flow to the load. The output capacitor C1 continues to smooth the output voltage. In operation, the duty cycle (the ratio of the turn-on time of the high side switch QH to the total switching period) is used to control the output voltage V1. By adjusting the duty cycle, the output voltage V1 can be regulated at a predetermined level.

In accordance with an embodiment, the switches (e.g., switches QH and QL) may be metal oxide semiconductor field-effect transistor (MOSFET) devices. Alternatively, the switches can be any controllable switches such as insulated gate bipolar transistor (IGBT) devices, integrated gate commutated thyristor (IGCT) devices, gate turn-off thyristor (GTO) devices, silicon-controlled rectifier (SCR) devices, junction gate field-effect transistor (JFET) devices, MOS controlled thyristor (MCT) devices, gallium nitride (GaN)-based power devices, silicon carbide (SiC)-based power devices and the like.

It should be noted that while FIG. 3 shows the switches QH and QL are implemented as single n-type transistors, a person skilled in the art would recognize there may be many variations, modifications and alternatives. For example, depending on different applications and design needs, the switches QH and QL may be implemented as p-type transistors. Furthermore, each switch shown in FIG. 3 may be implemented as a plurality of switches connected in parallel. Moreover, a capacitor may be connected in parallel with one switch to achieve zero voltage switching (ZVS)/zero current switching (ZCS).

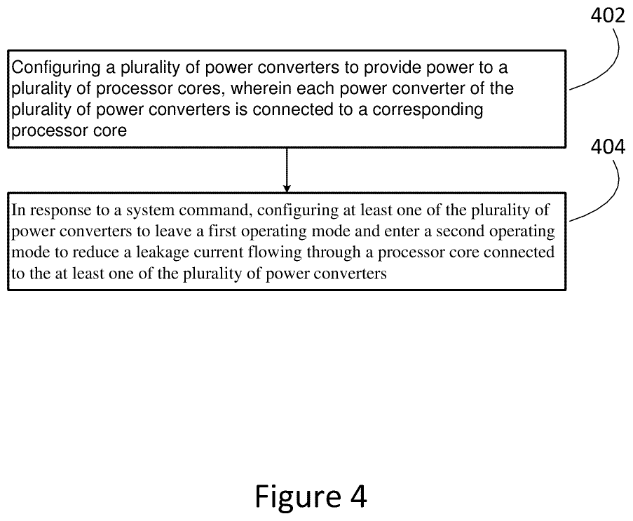

FIG. 4 illustrates a flow chart of a method for controlling the power conversion system shown in FIG. 1 in accordance with various embodiments of the present disclosure. This flowchart shown in FIG. 4 is merely an example, which should not unduly limit the scope of the claims. One of ordinary skill in the art would recognize many variations, alternatives, and modifications. For example, various steps illustrated in FIG. 4 may be added, removed, replaced, rearranged and repeated.

At step 402, a plurality of power converters is configured to provide power to a plurality of processor cores. Each power converter of the plurality of power converters is connected to a corresponding processor core.

At step 404, in response to a system command, at least one of the plurality of power converters is configured to leave a first operating mode and enter a second operating mode to reduce a leakage current flowing through a processor core connected to the at least one of the plurality of power converters.

The method further comprises in the first operating mode, configuring the at least one of the plurality of power converters to regulate an output voltage to a voltage level specified by the processor core, and in the second operating mode, disabling the at least one of the plurality of power converters.

The method further comprises in the first operating mode, configuring the at least one of the plurality of power converters to regulate an output voltage to a voltage level specified by the processor core, and in the second operating mode, configuring the at least one of the plurality of power converters to regulate an output voltage equal to zero.

The method further comprises in the first operating mode, configuring the at least one of the plurality of power converters to regulate an output voltage to a voltage level specified by the processor core, and in the second operating mode, configuring the at least one of the plurality of power converters to operate with a minimum duty cycle.

The method further comprises in the first operating mode, configuring the at least one of the plurality of power converters to regulate an output voltage to a voltage level specified by the processor core, and in the second operating mode, configuring the at least one of the plurality of power converters to regulate an output voltage to a level slightly below a leakage current threshold voltage of the processor core.

The method further comprises in the first operating mode, configuring the at least one of the plurality of power converters to regulate an output voltage to a voltage level specified by the processor core, and in the second operating mode, configuring the at least one of the plurality of power converters to regulate an output voltage equal to zero and operate with a variable switching frequency to reduce power consumption.

The method further comprises in the first operating mode, configuring the at least one of the plurality of power converters to regulate an output voltage to a voltage level specified by the processor core, and in the second operating mode, configuring the at least one of the plurality of power converters to operate with a minimum duty cycle and a variable switching frequency to reduce power consumption.

The method further comprises in the first operating mode, configuring the at least one of the plurality of power converters to regulate an output voltage to a voltage level specified by the processor core, and in the second operating mode, configuring the at least one of the plurality of power converters to operate with a minimum duty cycle and a fixed switching frequency to achieve a faster transient response time.

The method further comprises in the first operating mode, configuring the at least one of the plurality of power converters to regulate an output voltage to a voltage level specified by the processor core, and in the second operating mode, configuring the at least one of the plurality of power converters to regulate an output voltage to a level slightly below a leakage current threshold voltage of the processor core and operate with a variable switching frequency to reduce power consumption.

The method further comprises in the first operating mode, configuring the at least one of the plurality of power converters to regulate an output voltage to a voltage level specified by the processor core, and in the second operating mode, configuring the at least one of the plurality of power converters to regulate an output voltage to a level slightly below a leakage current threshold voltage of the processor core and operate with a fixed switching frequency to achieve a faster transient response time.

The method further comprises in response to the system command having a short sleep time of the at least one of the plurality of power converters, configuring the at least one of the plurality of power converters to operate with a minimum duty cycle and a fixed switching frequency to achieve a faster transient response time.

The method further comprises in response to the system command having a short sleep time of the at least one of the plurality of power converters, configuring the at least one of the plurality of power converters to regulate an output voltage to a level slightly below a leakage current threshold voltage of the processor core and operate with a fixed switching frequency to achieve a faster transient response time.

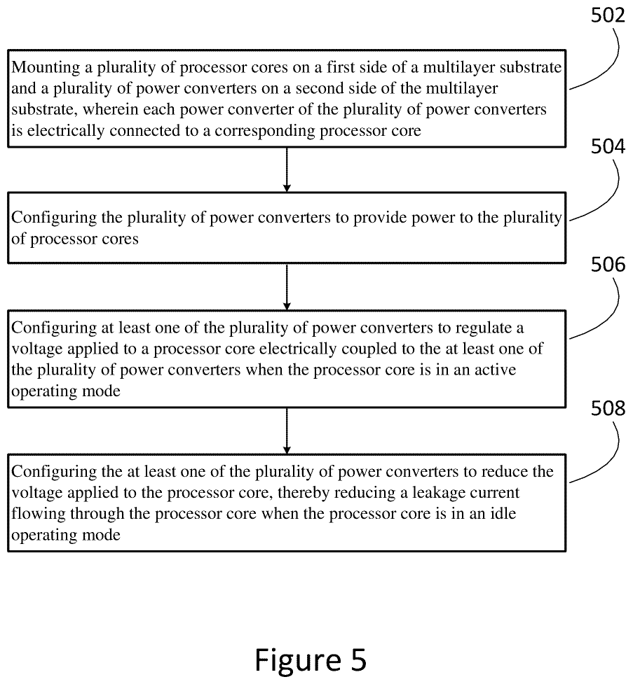

FIG. 5 illustrates a flow chart of another method for controlling the power conversion system shown in FIG. 1 in accordance with various embodiments of the present disclosure. This flowchart shown in FIG. 5 is merely an example, which should not unduly limit the scope of the claims. One of ordinary skill in the art would recognize many variations, alternatives, and modifications. For example, various steps illustrated in FIG. 5 may be added, removed, replaced, rearranged and repeated.

At step 502, a plurality of processor cores is mounted on a first side of a multilayer substrate, and a plurality of power converters is mounted on a second side of the multilayer substrate, wherein each power converter of the plurality of power converters is electrically connected to a corresponding processor core.

At step 504, the plurality of power converters is configured to provide power to the plurality of processor cores.

At step 506, at least one of the plurality of power converters is configured to regulate a voltage applied to a processor core electrically coupled to the at least one of the plurality of power converters when the processor core is in an active operating mode.

At step 508, the at least one of the plurality of power converters is configured to reduce the voltage applied to the processor core, thereby reducing a leakage current flowing through the processor core when the processor core is in an idle operating mode.

In some embodiments, when the processor core is in the idle operating mode, configuring the at least one of the plurality of power converters to reduce the voltage applied to the processor core comprises disabling the at least one of the plurality of power converters such that the voltage applied to the processor core is substantially zero.

In some embodiments, when the processor core is in the idle operating mode, configuring the at least one of the plurality of power converters to reduce the voltage applied to the processor core comprises regulating the voltage applied to the processor core to a level below a leakage current threshold voltage of the processor core.

In some embodiments, when the processor core is in the idle operating mode, configuring the at least one of the plurality of power converters to reduce the voltage applied to the processor core comprises operating the at least one of the plurality of power converters with a minimum duty cycle to reduce power consumption.

The method further comprises in the step of configuring the at least one of the plurality of power converters to reduce the voltage applied to the processor core, gradually reducing the voltage applied to the processor core by reducing the voltage applied to the processor core to a level slightly below a leakage current threshold voltage of the processor core, further reducing the voltage applied to the processor core to a voltage level corresponding to a minimum duty cycle of the at least one of the plurality of power converters, further reducing the voltage applied to the processor core to substantially zero, and thereafter disabling the at least one of the plurality of power converters by stopping switching activity.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed is:

1. A method comprising:
configuring a plurality of power converters to provide power to a plurality of processor cores, wherein each power converter of the plurality of power converters is connected to a corresponding processor core; and
in response to a system command, configuring at least one of the plurality of power converters to leave a first operating mode and enter a second operating mode to reduce a leakage current flowing through a processor core connected to the at least one of the plurality of power converters.

2. The method of claim 1, further comprising:
in the first operating mode, configuring the at least one of the plurality of power converters to regulate an output voltage to a voltage level specified by the processor core; and
in the second operating mode, disabling the at least one of the plurality of power converters.

3. The method of claim 1, further comprising:
in the first operating mode, configuring the at least one of the plurality of power converters to regulate an output voltage to a voltage level specified by the processor core; and
in the second operating mode, configuring the at least one of the plurality of power converters to regulate an output voltage equal to zero.

4. The method of claim 1, further comprising:
in the first operating mode, configuring the at least one of the plurality of power converters to regulate an output voltage to a voltage level specified by the processor core; and
in the second operating mode, configuring the at least one of the plurality of power converters to operate with a minimum duty cycle.

5. The method of claim 1, further comprising:
in the first operating mode, configuring the at least one of the plurality of power converters to regulate an output voltage to a voltage level specified by the processor core; and
in the second operating mode, configuring the at least one of the plurality of power converters to regulate an output voltage to a level slightly below a leakage current threshold voltage of the processor core.

6. The method of claim 1, further comprising:
in the first operating mode, configuring the at least one of the plurality of power converters to regulate an output voltage to a voltage level specified by the processor core; and
in the second operating mode, configuring the at least one of the plurality of power converters to regulate an output voltage equal to zero and operate with a variable switching frequency to reduce power consumption.

7. The method of claim 1, further comprising:
in the first operating mode, configuring the at least one of the plurality of power converters to regulate an output voltage to a voltage level specified by the processor core; and
in the second operating mode, configuring the at least one of the plurality of power converters to operate with a minimum duty cycle and a variable switching frequency to reduce power consumption.

8. The method of claim 1, further comprising:
in the first operating mode, configuring the at least one of the plurality of power converters to regulate an output voltage to a voltage level specified by the processor core; and
in the second operating mode, configuring the at least one of the plurality of power converters to operate with a minimum duty cycle and a fixed switching frequency to achieve a faster transient response time.

9. The method of claim 1, further comprising:
in the first operating mode, configuring the at least one of the plurality of power converters to regulate an output voltage to a voltage level specified by the processor core; and
in the second operating mode, configuring the at least one of the plurality of power converters to regulate an output voltage to a level slightly below a leakage current threshold voltage of the processor core and operate with a variable switching frequency to reduce power consumption.

10. The method of claim 1, further comprising:
in the first operating mode, configuring the at least one of the plurality of power converters to regulate an output voltage to a voltage level specified by the processor core; and
in the second operating mode, configuring the at least one of the plurality of power converters to regulate an output voltage to a level slightly below a leakage current threshold voltage of the processor core and operate with a fixed switching frequency to achieve a faster transient response time.

11. The method of claim 1, wherein:
in response to the system command having a short sleep time of the at least one of the plurality of power converters, configuring the at least one of the plurality of power converters to operate with a minimum duty cycle and a fixed switching frequency to achieve a faster transient response time.

12. The method of claim 1, wherein:
in response to the system command having a short sleep time of the at least one of the plurality of power converters, configuring the at least one of the plurality of power converters to regulate an output voltage to a level slightly below a leakage current threshold voltage of the processor core and operate with a fixed switching frequency to achieve a faster transient response time.

13. A method comprising:
mounting a plurality of processor cores on a first side of a multilayer substrate and a plurality of power converters on a second side of the multilayer substrate, wherein each power converter of the plurality of power converters is electrically connected to a corresponding processor core;
configuring the plurality of power converters to provide power to the plurality of processor cores;
configuring at least one of the plurality of power converters to regulate a voltage applied to a processor core electrically coupled to the at least one of the plurality of power converters when the processor core is in an active operating mode; and
configuring the at least one of the plurality of power converters to reduce the voltage applied to the processor core, thereby reducing a leakage current flowing through the processor core when the processor core is in an idle operating mode.

14. The method of claim 13, wherein:
when the processor core is in the idle operating mode, configuring the at least one of the plurality of power converters to reduce the voltage applied to the processor core comprises disabling the at least one of the plurality of power converters such that the voltage applied to the processor core is substantially zero.

15. The method of claim 13, wherein:
when the processor core is in the idle operating mode, configuring the at least one of the plurality of power converters to reduce the voltage applied to the processor core comprises regulating the voltage applied to the processor core to a level below a leakage current threshold voltage of the processor core.

16. The method of claim 13, wherein:
when the processor core is in the idle operating mode, configuring the at least one of the plurality of power converters to reduce the voltage applied to the processor core comprises operating the at least one of the plurality of power converters with a minimum duty cycle to reduce power consumption.

17. The method of claim 13, further comprising:
in the step of configuring the at least one of the plurality of power converters to reduce the voltage applied to the processor core, gradually reducing the voltage applied to the processor core by:
reducing the voltage applied to the processor core to a level slightly below a leakage current threshold voltage of the processor core;
further reducing the voltage applied to the processor core to a voltage level corresponding to a minimum duty cycle of the at least one of the plurality of power converters;
further reducing the voltage applied to the processor core to substantially zero; and
thereafter disabling the at least one of the plurality of power converters by stopping switching activity.

18. A system comprising:
a plurality of processor cores disposed on a first side of a multilayer substrate;
a plurality of power converters disposed on a second side of the multilayer substrate, wherein each of plurality of power converters comprises a smart power stage, an inductor and an output capacitor, and wherein the smart power stage comprises a driver, a high side switch and a low side switch;
a plurality of conductive paths in the multilayer substrate and coupled between the plurality of power converters and the plurality of processor cores, wherein through the plurality of conductive paths, each power converter of the plurality of power converters is electrically connected to a corresponding processor core; and
a controller configured to control at least one of the plurality of power converters to leave a first operating mode and enter a second operating mode, thereby reducing a leakage current flowing through a processor core connected to the at least one of the plurality of power converters.

19. The system of claim 18, wherein:
in the first operating mode, the controller is configured to regulate a voltage applied to a processor core electrically coupled to the at least one of the plurality of power converters; and
in the second operating mode, the controller is configured to disable the at least one of the plurality of power converters such that the voltage applied to the processor core is substantially zero.

20. The system of claim 18, wherein:
in the first operating mode, the controller is configured to regulate a voltage applied to a processor core electrically coupled to the at least one of the plurality of power converters; and
in the second operating mode, the controller is configured to control the at least one of the plurality of power converters to regulate a voltage applied to the processor core to a level below a leakage current threshold voltage of the processor core.
